(19) United States
(12) Patent Application Publication
(10) Pub. No.: US 2023/0390804 A1
(43) Pub. Date: Dec. 7, 2023

(54) VIBRATING SCREEN CONTROL ARRANGEMENTS

(71) Applicant: Schenck Process Australia Pty Limited, North Ryde NSW (AU)

(72) Inventors: Douglas Robert Teyhan, North Ryde NSW (AU); Jack Woodward, North Ryde NSW (AU); Mariusz Milewicz, North Ryde NSW (AU)

(21) Appl. No.: 18/249,247

(22) PCT Filed: Oct. 15, 2021
(86) PCT No.: PCT/AU2021/051208

§ 371 Date: Apr. 15, 2023

(30) Foreign Application Priority Data
Oct. 16, 2020 (AU) 2020903764

(51) Int. Cl. B07B 1/44; B07B 1/28; H02K 7/06; H02K 7/02; H02K 7/10

(52) U.S. Cl. CPC B07B 1/44; B07B 1/28; H02K 7/061; H02K 7/02; H02K 7/1004; B07B 2201/04

(57) ABSTRACT

The specification discloses a vibratory screening apparatus for screening mined ore materials utilizing elliptical vibration, the apparatus having a static section, a dynamic section including a screening deck, the apparatus having three pairs of rotary motion exciter cells positioned with a first group of three said rotary motion exciter cells on a first side of the dynamic section and a second group of three said rotary motion exciter cells on a second side of the dynamic section, each of the cells in said first group forming a pair with a respective one of the cells in the second group, the apparatus further including drive means for rotationally driving the cells, and mechanical synchronisation means linking rotation of a first said pair to a second said pair of the cells whereby, in use, rotation of said pairs of cells are mechanically synchronised.

### TECHNICAL FIELD

The present disclosure generally relates to vibrating screen apparatus for screening particularly iron ore, but potentially also other similar mined materials, and also to the control of such apparatus.

### BACKGROUND

Separating mined ore particles by size is a normal process that is performed in most mines irrespective of the material being extracted. This is typically achieved using some form of vibrating screen, screening apparatus. The screenability of mined ore changes with water content, particle size and whether the ore contains contaminates including clay contaminates. In some situations, water might be added to the ore being screened to assist with the screening process, however, this is progressively seen as problematic as water itself is, in many locations, a scarce resource, and moreover, the process can result in contaminated discharge water that needs to be handled in a safe and ecologically friendly manner. Such issues can impose added costs into the handling procedures. Therefore, while wet-screening and the addition of water is common, it is generally desirable, wherever possible, to carry out such screening processes without the need to add water to the screening process.

It is also the case that in many mines, the ore is subject to significant variations in naturally occurring water content during the year (i.e. wet season to dry season) and also to clay and other contaminants which provide greater problems when wet rather than dry. These factors cause difficulties with existing vibratory screening apparatus and processes and can prevent processing, or significantly increase costs associated with processing, or require the addition of water (which is undesirable for the reasons described above) to achieve adequate processing performance.

Elliptical motion type vibrating screens have been found to be reasonably effective in screening ore particles and particularly those particles that might be moisture loaded (surface moisture content greater than approximately 8% by mass), or might be strangely shaped that provide difficulties with passing through the screen media (panel) apertures and/or particles being stuck in apertures. Further it is possible that fine particles, and particularly moisture loaded fine particles, can pack into and at least partially block some or more of the apertures in the screening deck. Elliptical motion applied to the particles on the screening deck provides both a conveying (or retarding when required) motion in the longitudinal direction of the screening deck as well as lifting and dropping forces to the particles on the screen. Such elliptical motion vibration can assist with many of the problems that can be experienced with screening ore, particularly iron ore, particles, and can work on horizontal or sloping screening decks to provide a controlled or controllable transport rate. Ore particles receive both “up and back” pressure as well as “down and forward” pressure during normal screening processes. Elliptical vibratory motion applies pressure in all directions if a particle is stuck in a screen media (panel) aperture, but it does so with higher magnitude in the “up” direction than occurs with circular motion. The “up and back” forces followed by “down and forward” forces causes a stuck particle to wobble in the screen aperture and even to rotate to present a different shape aspect to the screen apertures. Turning the particle increases the chance of it going through the aperture or being thrown out of the screen aperture. Thus, wobbling action can also loosen fine material that is sticking to larger particles and reduce “piggy back” fines going with the oversize particle stream.

Achieving control of the elliptical vibration motion is also seen to be important for a number of reasons. Conventional linear motion and circular motion vibrating machines typically have a fixed orbit characteristic which limits the ability of the machines to adapt to the processing requirements. Whilst some elliptical motion vibrating screening systems implement a form of mechanical synchronisation, these render the elliptical motion screen unable to adapt to the process. Firstly, the rotational direction affects the speed of transport of ore particle material along the screening deck. Rotational movement that is with the flow in the upward part of the vibratory motion of the material on the screening deck tends to increase the speed of material flow on the screening deck. Rotational movement that is counter to the material flow in the upward part of the vibratory motion of the material on the screening deck tends to reduce the flow rate of the material on the deck. Further altering the angle of the major axis of the ellipse imposed on the material vibration relative to the screening deck upper face affects upward and downward forces applied to the particles on the screening deck and therefore performance characteristics of the screening deck. It is generally desirable for screening deck(s) that are vibrated using multiple driven vibration exciter cells generally require rotation of the vibration exciter cells to be synchronised to ensure proper control of and stabilisation of the vibrations imposed on the screening deck(s). This is not normally done at present. Attempts to achieve this by electrical or electronic means alone has not proven to be all that satisfactory under certain operating conditions such as high loading and when the ore contains high levels of naturally occurring moisture content. Where synchronisation is achieved by electronic means alone, the system can be subject to high phasing instability and increased power demand during operation. Available mechanical synchronisation systems in prior art disclosures render the adjustability of the orbit motion of the vibrating screen not to function. Where adjustment can only be made by mechanical means, the machine is required to be taken out of service to make modifications to the drive assembly. Controlling characteristics of the elliptical vibration including the ability to change these characteristics without stopping processing, while also maintaining stability of the elliptical vibration is important to achieve good performance processing of very dry ore particle materials without significant added costs or the need to add significant water volumes to processing methods.

The specification of International Patent Publication No WO2017/202929A1 discloses a vibratory screening machine for screening material according to size that includes three rotatable unbalanced drive shafts equally spaced along the screening deck, the drive shafts being driven by a drive mechanism to effect synchronous rotation of the drive shafts in the same direction. The arrangement disclosed results in a fixed circular vibration orbit path. French Patent Application No FR 3006612A1 discloses a vibratory screening machine utilizing two unbalanced weights rotated in opposite directions around individual shafts to establish vibration. Chinese Patent No CN 208261209U discloses a vibratory screening machine utilizing three adjacent excitation motors each being controlled by an excitation motor control box, two of the adjacent positioned excitation motors being coupled by a timing belt. The disclosure indicates that the two excitation motors coupled by the timing belt may be energized and deenergized according to a set interval by the excitation motor control box.

The difficulty with the subject matter of the above discussed prior art disclosures is that they are not capable of being adjusted during use of the equipment, that is during operation, to permit operating characteristics of the screen deck to be adjusted to suit process requirements such as high moisture applications.

The objective of this disclosure is to provide vibratory screening apparatus capable of processing iron ore materials and other similar materials utilising vibration motion through a greater degree of effective control of the operating parameters including allowing in process adjustment or variation of the operating parameters while maintaining proper synchronisation stability throughout. It is preferred that this be achieved in a simple and cost effective manner. A preferred objective is to achieve effective control over particularly an elliptical vibration applied to a screening deck in vibratory screening apparatus. A still further preferred objective is to provide an improved method of operating vibratory screening apparatus.

### SUMMARY OF THE DISCLOSURE

In accordance with a first aspect of this disclosure, there is provided a vibratory screening apparatus including a static section; a dynamic section including a screening deck; multiple rotary motion exciter cells including at least three pairs of said rotary motion exciter cells positioned with a first group of three said rotary motion exciter cells on a first side of said dynamic section and a second group of three said rotary motion exciter cells being located on a second side of said dynamic section, each of said rotating exciter cells in said first group forming a pair of said rotary motion exciter cells with a respective one of the rotary motion exciter cells in said second group; drive means for rotationally driving each of said rotary motion exciter cells whereby a first said pair of said rotary motion exciter cells rotate in the same direction as a second said pair of said rotary motion exciter cells, and a third said pair of said rotary motion exciter cells having control means configured to enable rotation of said third pair of said rotary motion exciter cells in a rotational direction opposite to said first and said second pairs of said rotary motion exciter cells; and mechanical synchronisation means linking rotation of said first said pair of said rotary motion exciter cells to said second said pair of said rotary motion exciter cells wherein, in use, rotation of said first said pair and said second said pair of said rotary motion exciter cells is mechanically synchronised and is adapted to impose a stabilised vibratory motion, preferably elliptical vibratory motion, to said dynamic section.

Preferably, the aforesaid vibratory screening apparatus may further include electronic or electrical control means to control phase relationship and direction of rotation of said third said pair of rotary motion exciter cells relative said first and said second pairs of rotary motion exciter cells.

The above described drive means for rotationally driving each of said rotary motion exciter cell pairs may be an electric motor. The two co-rotating exciter cell pairs may have electrical wiring or other electrical control means configured to maintain co-rotation of the exciter cell pairs, and electronic synchronisation control module means to provide at least some load sharing between co-rotating exciter cell pairs. Operation of the mechanical synchronisation means between co-rotating exciter cell pairs ensures stability of angular velocity and deflections. The third said pair of rotary motion exciter cells may have appropriate electrical wiring or other means including electronic control means, for ensuring the opposed direction of rotation compared to the first pair and the second pair of co-rotating rotary motion exciter cells, said electronic control means also enabling phasing changes within electron control of the third said pair of rotary motion exciter cells permitting synchronisation adjustment between the co-rotating first said pair and the second said pair of the rotary exciter cells and the counter-rotating exciter cells, to permit complete live rotary adjustment of an operating stroke of the vibration of the vibrating screen, preferably through 360°. With elliptical motion, the major axis of the elliptical motion may be adjusted, preferably through 360°, preferably live during operation of the screen deck.

It may be desirable to further include electronic or electrical synchronisation of rotation of the first said pair and the second said pair of said rotary motion exciter cells rotating in the same direction with rotation of the third said pair of said rotary motion exciter cells. Still further, it may also be desirable to also include electrical synchronisation between the first said pair and the second said pair of said rotary motion exciter cells as this will reduce demand on the mechanical synchronisation means. Providing the above described mechanical synchronisation means with the arrangement of rotary motion exciter cells and the drive means therefore has been found to provide effective control and controllability of vibratory screening apparatus utilising rotary motion exciter cells with much improved synchronisation stability when compared to attempts to electrically or electronically synchronise, the drive motors driving the exciter cells. Moreover, the arrangement provides simplicity and a robust mechanical construction, particularly, when it will be recognised the apparatus will be used at remote mine sites in most circumstances.

Further preferred aspects of the disclosure are set out in the following paragraphs. Conveniently, the drive means may include a drive motor rotationally driving each of the aforesaid pairs of rotary motion exciter cells. As a possible alternative the drive means might include a drive motor rotationally driving each of the individual rotary motion exciter cells, that is, the exciter cells on either side of the screening deck. In the case of a drive motor arranged to drive each of the pairs of rotary motion exciter cells, the arrangement will include a rotational drive shaft traversing between the first side and the second side of the dynamic section.

Preferably each of the drive motors is statically mounted, either to the static section or separately, and has an output drive shaft operationally connected to a flexible coupling drive shaft rotationally driving, in use, a respective one of said rotary motion exciter cells.

Conveniently, the screening deck of the vibratory screening apparatus has an infeed end and a discharge end, the first said pair of said rotary motion exciter cells being located relatively closer to said infeed end, and said second pair of said rotary motion exciter cells being located relatively closer to said discharge end. This configuration is desirable to achieve electronic stabilization. Preferably, the third said pair of rotary motion exciter cells are positioned generally between said first said pair and second said pair of rotary motion exciter cells and preferably in close proximity to a centre of gravity of a vibrating screen body including the screening deck. The just described feature is needed to provide electronic synchronisation stability. Furthermore, it is needed to ensure that rotational torque effects do not destabilise the system.

Preferably, the mechanical synchronisation means is operationally connected to the output drive shafts of the drive motors rotationally driving said first said pair and said second said pair of said rotary motion exciter cells. The mechanical synchronisation means may include an endless timing belt operationally connecting pulleys mounted to the output drive shafts. In another possible preferred arrangement, the mechanical synchronisation means may include an endless timing belt operationally connecting pulleys mounted to said flexible coupling drive shafts. In yet another possible preferred arrangement, the mechanical synchronisation means may include an endless timing belt operationally connecting pulleys mounted to a rotational drive shaft of the rotary motion exciter cells located on the second side of said dynamic section of the first said pair, and the second said pair of the rotary motion exciter cells.

Preferably, the rotary motion exciter cells are located in a central region of side walls of the vibratory screening apparatus. Conveniently, the first group and the second group of the rotary motion exciter cells have axes of rotation positioned generally in line with a longitudinal direction of said screening deck. In another possible preferred arrangement, the first group and the second group of said rotary motion exciter cells have axes of rotation positioned generally in the form of a triangle, with the axes of rotation of said first said pair and said second said pair of said rotary motion exciter cells being positioned generally adjacent to an upper extremity of the dynamic section, and the axes of rotation of said third said pair of said rotary motion exciter cells being located below the axes of rotation of said first said pair and said second said pair of said rotary motion exciter cells. In yet another possible preferred arrangement, the first group and the second group of said rotary motion exciter cells have axes of rotation positioned generally in the form of a triangle, with the axes of rotation of the third said pair of said rotary motion exciter cells being positioned adjacent to an upper extremity of the dynamic section, and the axes of rotation of said first said pair and said second said pair of the rotary motion exciter cells being located at a lower position.

In preferred embodiments, the dynamic section includes side walls on either side of the screening deck that extend upwardly from and longitudinally along the screening deck. Conveniently, the side walls may also extend downwardly from the screening deck. Preferably, the second deck may be a second screening deck. It is envisaged possible to include at least one further possible screening deck in a stack of three or more such screening decks. The structure and configuration of the or each screening deck may be selected as desired and may be connected to the dynamic section to be subject to vibratory motion imposed thereby. The screening deck(s) may be generally horizontal or inclined or sloped downwardly from the infeed end to the discharge end. The upper face of the screening deck(s) may also be flat, multi-sloped (concave curved) facing upwardly in the longitudinal direction between the infeed end and the discharge end.

In a further preferred embodiment, the screening deck includes a plurality of longitudinally spaced transverse tubular support members connected at either end to a respective said side wall, said tubular support members having a circular cross section with a plurality of circumferentially extending flanges spaced along the length of the support member, the circumferentially extending flanges enabling longitudinally extending rails to be connected thereto, the longitudinally extending rails enabling screening panel modules to be connected to the longitudinally extending rails to form an upwardly directed face of the screening deck.

In yet another preferred embodiment, in a vibratory screening apparatus, control means may be arranged to control operational parameters of said drive means including rotational speed of said rotary motion exciter cells and direction of rotation of said rotary motion exciter cells during operation of said vibratory screening apparatus. The foregoing also enables torque demand matching and phase control allowing full live, that is during operation, adjustability of the operating stroke of the screening deck. Conveniently, the control means may be software based whereby when the rotary motion exciter cells are stationary, encoders will register a “zero” or “home” position. As the rotary motion exciter cells rotate (even though one or one pair is rotating in a counter direction), the encoder can then determine a relative position. When a command is enacted to change the phase position, a user enters a change in angle that is required (the angle change is half the phase relationship change), and the PLC will issue a command to instantaneously increase the rotational velocity of the advancing rotary motion exciter cell until the correct phase relationship is achieved.

In accordance with a separate aspect of this disclosure, there is provided a vibratory screening apparatus including a static section; a dynamic section including a screening deck; at least three rotary motion exciter cells mounted to said dynamic section whereby rotation of said rotary motion exciter cells imposes a vibratory motion on said dynamic section relative to said static section; drive means for rotationally driving each of said rotary motion exciter cells; and mechanical synchronisation means mechanically linking rotation of a first one of said rotary motion exciter cells to at least a second one of said rotary motion exciter cells with at least a third one of said rotary motion exciter cells not being linked by said mechanical synchronisation means, whereby rotation of at least said first and said second rotary motion exciter cells occur in a common rotational direction and are synchronised together. Synchronisation may occur by said mechanical synchronisation means for operational stability and separately by electronic stabilization means for torque matching and load sharing.

Conveniently, in the aforesaid separate aspect, multiple said rotary motion exciter cells are provided arranged in pairs with each said pair having a respective said rotary motion exciter cell positioned on opposed sides of said dynamic section with the rotary motion exciter cells of each said pair being constrained to rotate in the same direction. Preferably, the mechanical synchronisation means mechanically links rotation of at least three said pairs of said rotary motion exciter cells. Preferably, the common rotational direction may be reversible. The vibratory screening apparatus may also provide control means that is configured to enable rotation of said third one of said rotary motion exciter cells in a rotational direction counter to said common rotational direction.

In accordance with a yet further preferred aspect, the disclosure provides a method of operating a vibratory screening apparatus having a static section, a dynamic section including a screening deck, at least three rotary motion exciter cells mounted to said dynamic section whereby rotation of said rotary motion exciter cells impose a vibratory motion on said dynamic section relative to said static section, and drive means being arranged to rotationally drive each of said rotary motion exciter cells; said method including providing:
mechanical synchronisation means for mechanically linking rotation of a first one of said rotary motion exciter cells to at least a second one of said rotary motion exciter cells whereby rotation of at least said first and said second rotary motion exciter cells occur in a common rotational direction; and
control means controlling at least direction of rotation of a third one of said rotary motion exciter cells, said method further including carrying out screening of ore particulate material on said screening deck while rotating at least said third one of said rotary motion exciter cells in a direction counter to said common rotational direction of at least said first and said second rotary motion exciter cells.

The aforesaid control means may be electronically or electrically based whereby both direction of rotation and phase relationship is adjustable, conveniently during live operation, of the third one of said rotary motion exciter cells with the first one and the second one of the rotary motion exciter cells. Such electronically or electrically based control means are well understood in the technical field and are not further described in this specification. In another possible configuration this control means might be hydraulically or pneumatically operated.

Preferably, the aforesaid method involves said control means also controlling phase relationship of the third one of said rotary motion exciter cells relative to a selected one, or groups of, or all other said rotary motion exciter cells.

It will be understood that the terms “comprises”, “comprising”, “includes”, and/or “including” when used herein, specify the presence of stated features, items, steps, operations, elements, and/or components, but do not preclude the presence or addition of one or more other features, items, steps, operations, elements, components, and/or groups thereof.

Various objects, features, aspects and advantages of the subject matter of this disclosure will become more apparent from the following detailed description of a number of possible preferred embodiments or possible preferred variants illustrated in accompanying drawings.

### BRIEF DESCRIPTION OF THE DRAWINGS

FIG. 1 is a perspective view of vibratory screening apparatus utilising rotary motion exciter cells for creating elliptical vibration motion on the screening deck of the screening apparatus;

FIG. 2 is a perspective view of the vibratory screening apparatus of FIG. 1 showing the other side;

FIG. 3 is an end elevation view of the vibratory screening apparatus shown in in FIG. 1;

FIG. 4 is a detailed perspective view of the rotary motion exciter cells and drive motors therefor shown in FIG. 1;

FIG. 5 is a detailed perspective view of the drive motors and associated drive shafts and control equipment illustrated in FIG. 1;

FIG. 6 is a detailed view of part of the control equipment illustrated in FIG. 5;

FIGS. 7 and 8 are side elevation views of a vibratory screening apparatus illustrating alternative possible positioning of the rotary motion exciter cells and drive motors to that shown in FIG. 1; and

FIGS. 9 and 10 are end elevation views similar to FIG. 3, illustrating possible alternative positioning of control equipment and drive motor location.

### DETAILED DESCRIPTION

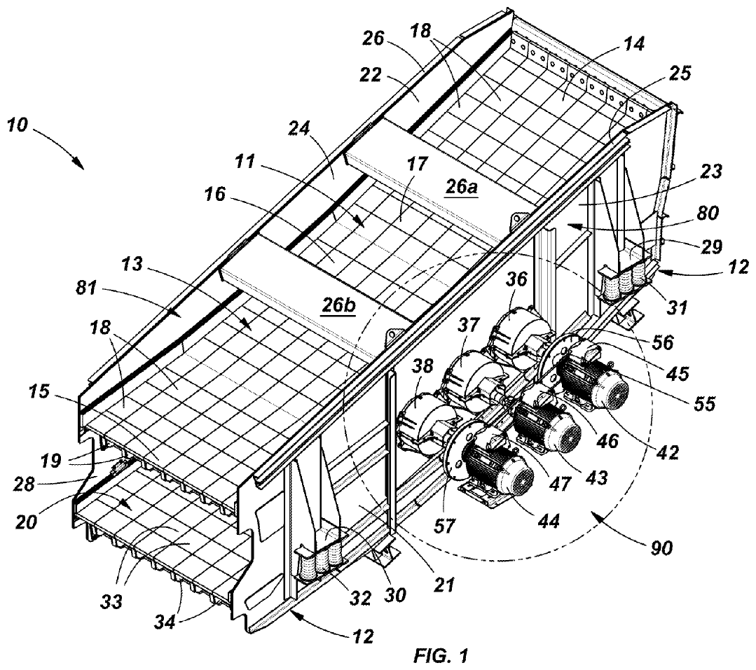

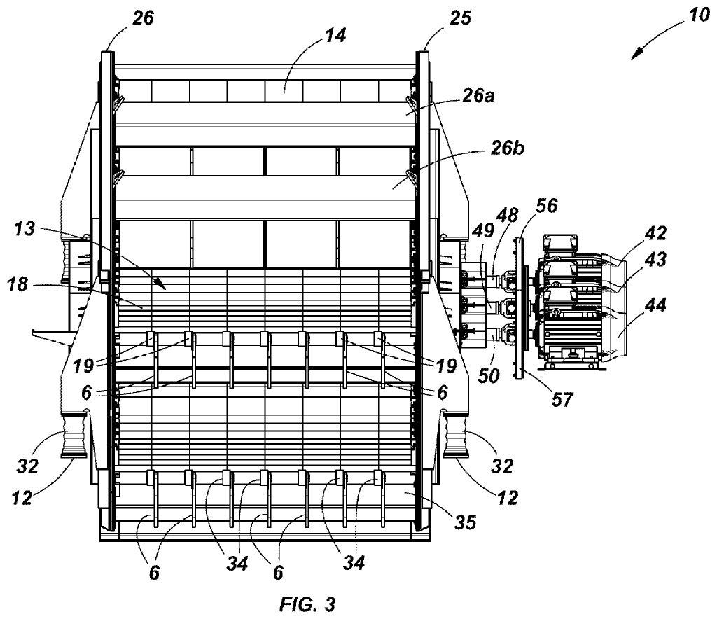

Referring initially to FIG. 1, a vibratory screening apparatus 10 is illustrated including an upper dynamic section 11 capable of vibratory movement relative to a lower static section 12 shown schematically but not in particular structural form in FIGS. 1 and 3. The dynamic section 11 includes a screening deck 13 having an infeed end 14 for receiving particulate ore material for screening, a discharge end 15 and a central screening region 16 between the infeed end 14 and 30 the discharge end 15. The central screening region 16 presents an upwardly facing concave surface 17 formed by a plurality of screening modules 18 secured by any conventionally known means to longitudinally extending mounting rails 19. The screening modules 18 may be configured in accordance with any known constructions for such screening modules typically, but not exclusively, including perforations or openings to pass particulate ore material to a lower deck 20. The lower deck 20 may simply collect and transport collected ore material, or may be a second screening deck of any desired configuration. The lower deck 20 may be mounted to side walls 21, 22 of opposed sides 80, 81 of the dynamic section 11. The screening deck 13 and the second deck 20 may then be subjected to similar elliptical vibrations imposed by the rotary motion exciter cells described further below. The upper screening deck 13 slopes or is inclined from the infeed end 14 to the discharge end 15.

The side walls 21, 22 of the upper dynamic section 11 includes side wall sections 23, 24 extending upwardly above the screening deck 13. Cross bracing beams 26a, 26b are formed from tubular rectangular steel and are connected generally to the side wall sections 23, 24 adjacent their upper edges 25, 26. Lower sections 27, 28 of the side walls 21, 22 extend downwardly below the upper screening deck 13 and includes supports 29, 30 for spring assemblies 31, 32 at opposed end regions positioned between the static section 12 and the dynamic upper section 11. The lower deck 20 may be constructed of suitable screen modules 33 mounted on longitudinally extending rails 34. As is best seen in FIG. 3, the longitudinal extending mounting rails 19 of the screening deck 13 are mounted on transverse support beams 35 spaced along the length of the screening deck 13. The support beams 35, are tubular steel with a circular cross-section and with spaced circumferential flanges 36, the flanges 36 enabling the mounting rails 19 to be connected thereto. Preferably, a two layer rubber armour layer covers the outer surfaces of the support beams 35 with the outer layer being harder and hard wearing with the inner layer being softer and more resilient. The structure and configuration of the support beams 35 (see FIG. 3) provide improved torsion strength for the dynamic section 11 and minimises obstruction of ore particulate material dropping through the screening region 16 of the screening deck 13 to the lower deck 20.

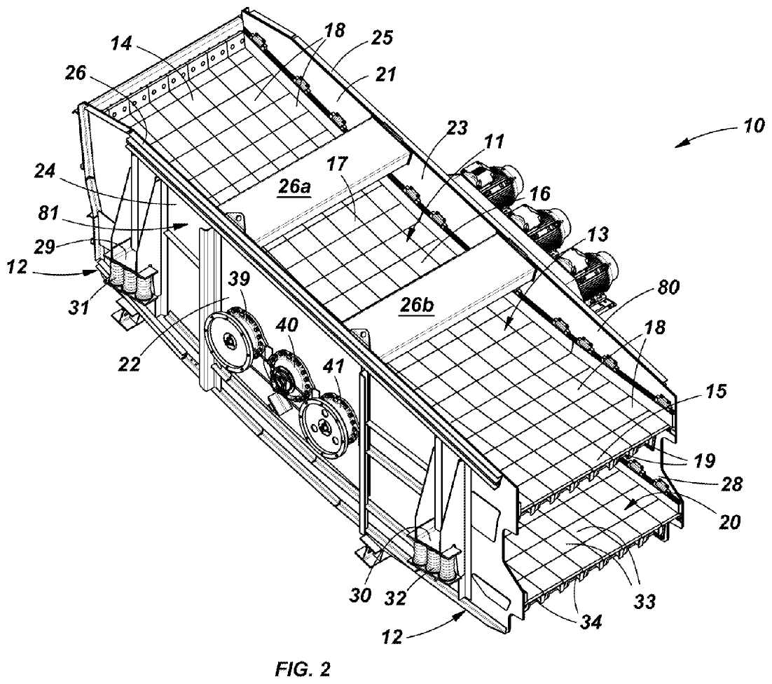

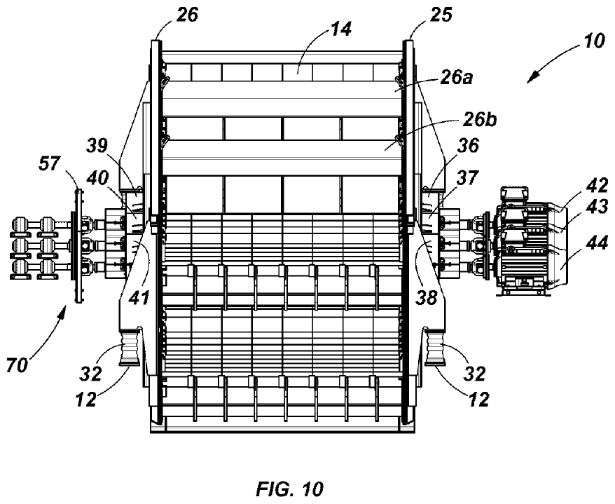

FIG. 1 further illustrates the mechanisms and drive arrangements therefor that enable a controlled and controllable elliptical vibratory motion to be imposed on the upper dynamic section 11, and as a result, on the screening deck 13. These mechanisms include rotary motion exciter cells 36, 37 and 38 rigidly mounted to the side wall 21 of the dynamic section 11 with their axes of rotation being in line in the longitudinal direction of the screening deck 13 and generally parallel to and below the level of the screening deck 13. The rotary motion exciter cells 36, 37 and 38 are arranged in pairs with similar rotary motion exciter cells 39, 40 and 41 mounted rigidly to the opposed side wall 22 (see FIG. 2). The rotary motion exciter cells 39, 40 and 41 may be driven via interconnecting drive shafts extending across the screening apparatus from the rotary motion exciter cells 36, 37, 38, or in the alternative, might be driven directly by their own dedicated drive motors as shown, for example, in FIG. 9. The rotary motion exciter cells 36-41 may be “direction force” exciters such as the DF series of exciters available from “Schenck Process” including DF504S. Alternatively, they may also be “rotary force” exciters such as the VZ series of such exciters available from “Schenck Process” including VZ501S. Equivalent vibration motion exciter cells available from other sources might also be utilised. These exciter cells are well known and will be within the knowledge of the skilled addressee and therefore are not further described in this specification. These vibration generating exciter cells are operated in a rotary manner and the terminology “rotary motion exciter cell or cells” is intended to identify a rotary driven vibration generating cell of the aforementioned type. The rotary motion exciter cells generally create a circular vibratory motion individually but the arrangement of same in the vibratory screening apparatus 10 and their rotation relative to one another enables a controlled and controllable elliptical vibration to be imposed on the dynamic section 11 and thereby the screening deck 13 and potentially other screening decks forming part of the dynamic section 11 of the vibratory screening apparatus 10. While the preferred embodiment disclosed herein includes three pairs of rotary motion exciter cells, it is possible that additional excited cells could be employed.

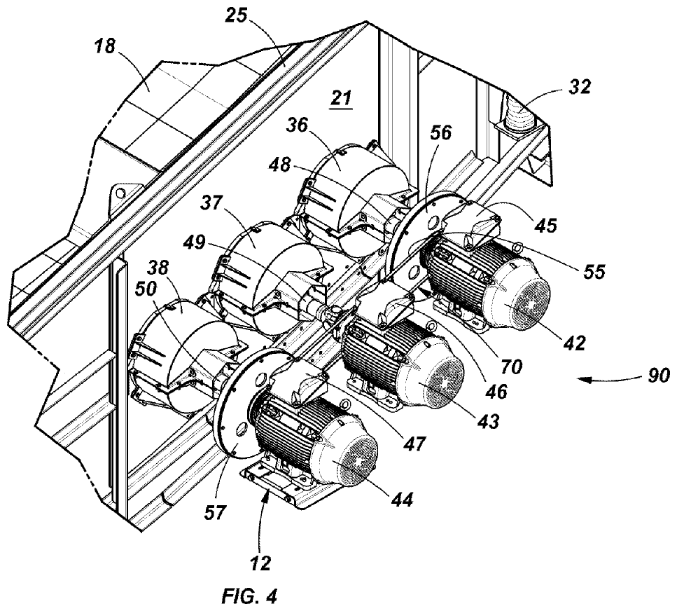

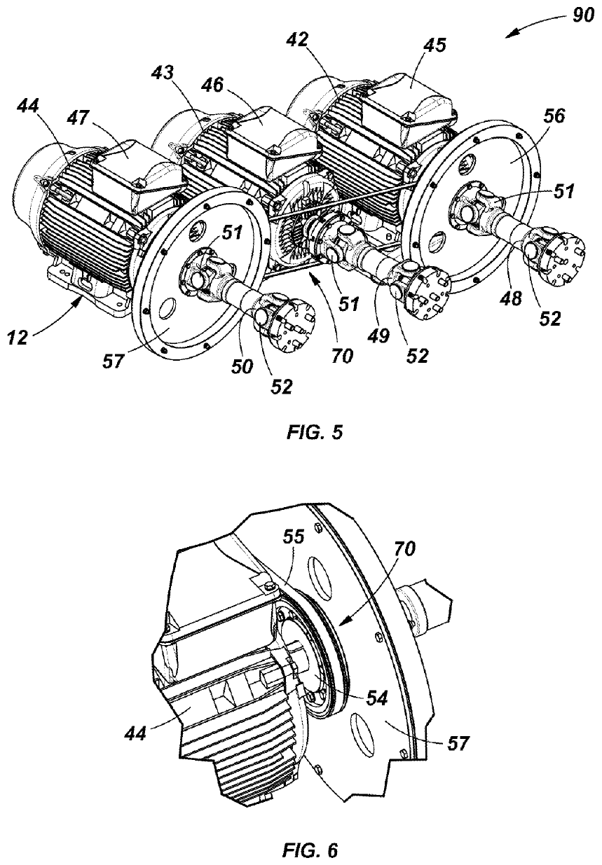

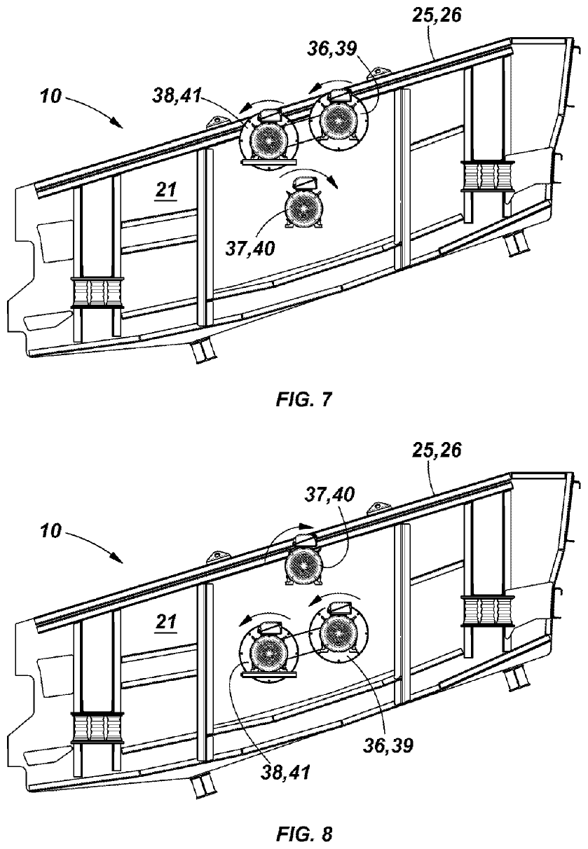

FIGS. 1, 3, 4, 5 and 6 illustrate one preferred embodiment of drive means 90 for driving the rotary motion exciter cells 36-41. This embodiment proposes a drive motor 42, 43 and 44 driving respectively the rotary motion exciter cells 36, 37 and 38. Each of the drive motors 42, 43 and 44 are electric motors but it is possible other forms of drive motors could be used. The drive motors 42, 43, and 44 are statically mounted either to the static section 12 of the vibratory apparatus 10 or separately therefrom. The drive motors 42, 43 and 44 include control means 45, 46, and 47 for each drive motor whereby various operating parameters can be varied such as (but not limited to) output speed and direction of rotation of the drive output.

An interconnecting drive shaft 48, 49 and 50 extends between a respective said drive motor 42, 43 and 44 and a respective one of the rotary motion exciter cells 36, 37 and 38. Because, in use, the exciter cells 36, 37 and 38 are vibratory with the dynamic section 11, the interconnecting drive shafts 48, 49 and 50 need to have some degree of flexibility. In the illustrated embodiments, this flexibility is achieved by providing “universal joints” 51, 52 generally at opposed ends of the interconnecting drive shafts 48, 49 and 50. Other forms of “flexibility” in the coupling drive shafts 48, 49 and 50 could also be used including a CV shaft (constant velocity joint), a flex coupling shaft or similar.

The drive motor 42 and coupled exciter cell 36 generally closest to the infeed end 14 of the screening deck 13, together with the drive motor 44 and coupled exciter cell 38 generally closest to the discharge end 15 of the screening deck 13, are constrained by the controller means or by any other means, to rotate in the same direction although the common direction might be selectable, i.e. either in the clockwise or anti clockwise direction. This direction selection can occur in use, that is, the screening apparatus 10 does not need to be shut down for a lengthy period. A command direction signal can be given to change operating parameters while the apparatus is being operated. The vibratory screening apparatus may stop before restarting with the new operating parameters but no long shut down period is required. Changing the direction of rotation of the exciter cells 36, 38 and their paired exciter cells 39, 41 on the other side of the screening apparatus 10 either promotes or retards the flow of material on the screening deck 13. The middle drive motor 43 and its coupled exciter cell 37 are electronically controlled to rotate in an opposite direction to that of the drive motors 42, 44 to achieve elliptical form of the vibration imposed on the screening deck 13.

In the illustrated embodiment of FIGS. 1 to 6, mechanical synchronisation means 70 is provided linking rotation of the exciter cell pairs 36/39 and 38/41 although the mechanical synchronisation means is directly linking exciter cells 36 and 38 in the illustrated embodiment. The mechanical synchronisation means includes timing belt pulleys 53, 54 rigidly mounted for rotation with the output drive shafts of each of the drive motors 42, 44 with the timing belt pulleys 53, 54 being connected in a synchronising manner by an endless timing belt 55. Other forms of mechanical synchronisation might also be utilised. A flywheel 56, 57 is also mounted to each of the output drive shafts of each of the drive motors 42, 44 although this is a preferred option and not considered essential. It would also be desirable to provide some means for ensuring operational tensioning of the timing belt 55 including a suitable adjustable idler pulley along the timing belt length or by allowing for adjustment of at least one of the drive motors 42, 44 and associated equipment.

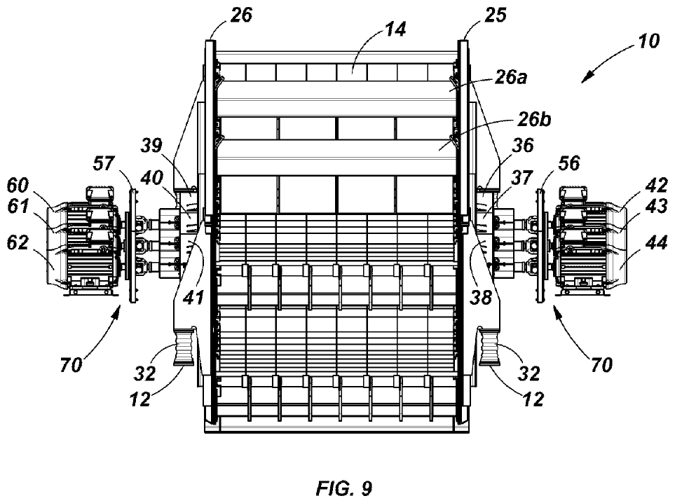

FIGS. 7 and 8 illustrate potential possible variations to the positioning of the pairs of rotary motion exciter cells 36/39, 37/40 and 38/41. In these embodiments, the rotary motion exciter cell pairs are configured with their axes of rotation located in a triangular pattern. In FIG. 7, the exciter cell pairs 36/39 and 38/41 that are arranged to co-rotate are located adjacent the upper edges 25, 26 of the side walls 21, 22 and like the embodiment of FIGS. 1-6 are synchronised by an interconnecting endless timing belt operationally mounted to output drive shafts of drive motors driving the exciter cell pairs 36/39 and 38/41. The middle exciter cell pair 37/40 is located at a lowered central position generally below the screening deck 13. As with the earlier embodiment, the middle exciter cell pair 37/40 is also constrained to rotate in an opposite direction to the two pairs 36/39 and 38/41. In FIG. 8, the exciter cell pairs 36/39 and 38/41 are positioned at a lowered central position generally below the screening deck 13. As with FIG. 7, the exciter cell pairs 36/39 and 38/41 are controlled to co-rotate and are synchronised via an interconnecting endless timing belt connecting timing belt pulleys mounted to drive shafts of drive motors driving the exciter cell pairs 36/39 and 38/41. The middle exciter cell pair 37/40 is positioned adjacent the upper edges 25, 26 of the side walls 21, 22 and is controlled to rotate in a direction opposite to the direction of rotation of the exciter cell pairs 36/39 and 38/41. It will of course be appreciated that other arrangements for configuring positioning of the rotary motion exciter cells are possible, that may provide an elliptical motion imposed upon the screening deck or decks or if desired, some other form of vibration.

FIGS. 9 and 10 show vibratory screening apparatus 10 similar to earlier disclosed and described embodiments where the rotary motion exciter cells 39, 40 and 41 on one side, and 36, 37 and 38 on the other side are each driven by separate drive motors 60, 61 and 62 and 42, 43 and 44. This arrangement avoids the need for coupling opposed pairs of rotary motion exciter cells with coupling drive shafts transversely crossing the vibratory screening apparatus 10 but does increase the number of drive motors and the mechanised synchronisation means 70. FIG. 10 illustrates an arrangement similar to FIGS. 1 to 6 except that the flywheels 56, 57 and the mechanical synchronisation means 70 such as the time belt pulleys 53, 54 and synchronising timing belt 55 have been moved to the second side of the vibratory screening apparatus 10 opposite that on which the drive motors 42, 43 and 44 are located.

The specification discloses a preferred embodiment including a number of possible variations that could be utilised. For instance the flywheels described and illustrated might be omitted in part or completely and the number and arrangement of the rotary motion exciter cells could be varied. For example five pairs of rotary motion exciter cells might be used. Further variations and changes will be apparent to those skilled in this art within the scope of the accompanying claims and such changes are included in this disclosure.

1. A vibratory screening apparatus including a static section; a dynamic section including a screening deck; multiple rotary motion exciter cells including at least three pairs of said rotary motion exciter cells positioned with a first group of three said rotary motion exciter cells on a first side of said dynamic section and a second group of three said rotary motion exciter cells being located on a second side of said dynamic section, each of said rotary motion exciter cells in said first group forming a pair of said rotary motion exciter cells with a respective one of the rotary motion exciter cells in said second group;
drive means for rotationally driving each of said rotary motion exciter cells whereby a first said pair of said rotary motion exciter cells rotate in a common direction with a second said pair of said rotary motion exciter cells, and a third said pair of said rotary motion exciter cells having control means configured to enable rotation of said third pair of said rotary motion exciter cells in a rotational direction opposite to said first and said second pairs of said rotary motion exciter cells; and
mechanical synchronisation means linking rotation of said first said pair of said rotary motion exciter cells to said second said pair of said rotary motion exciter cells wherein, in use, rotation of said first said pair and said second said pair of said rotary motion exciter cells is mechanically synchronised and is adapted to impose a stabilised vibratory motion to said dynamic section.

2. A vibratory screening apparatus according to claim 1 further including electronic or electrical control means to control phase relationship and preferably direction of rotation of said third said pair of rotary motion exciter cells relative said first and said second pairs of rotary motion exciter cells.

3. A vibratory screening apparatus according to claim 1 wherein said screening deck has an infeed end and a discharge end, the first said pair of said rotary motion exciter cells being located relatively closer to said infeed end, and said second pair of said rotary motion exciter cells being located relatively closer to said discharge end.

4. A vibratory screening apparatus according to claim 3 wherein said third said pair of rotary motion exciter cells are positioned generally between said first said pair and said second said pair of rotary motion exciter cells.

5. A vibratory screening apparatus according to claim 4 where said third said pair of rotary motion exciter cells are positioned at or in close proximity to a centre of gravity of said dynamic section.

6. A vibratory screening apparatus according to claim 1 wherein said drive means includes a drive motor rotationally driving each of said first said pair, said second said pair, and said third said pair of said rotary motion exciter cells.

7. A vibratory screening apparatus according to claim 1 wherein said drive means includes a drive motor rotationally driving each said rotary motion exciter cell.

8. A vibratory screening apparatus according to claim 6 wherein each said drive motor is statically mounted having an output drive shaft operationally connected to a flexible coupling drive shaft rotationally driving, in use, a respective one of said rotary motion exciter cells.

9. A vibratory screening apparatus according to claim 8 wherein each said first said pair, said second said pair, and said third said pair of said rotary motion exciter cells are connected by a rotational drive shaft traversing between said first side and said second side of said dynamic section.

10. A vibratory screening apparatus according to claim 8 wherein said mechanical synchronisation means is operationally connected to the output drive shafts of the drive motors rotationally driving said first said pair and said second said pair of said rotary motion exciter cells.

11. A vibratory screening apparatus according to claim 10 wherein said mechanical synchronisation means includes an endless timing belt operationally connecting pulleys mounted to the output drive shafts.

12. A vibratory screening apparatus according to claim 8 wherein said mechanical synchronisation means includes an endless timing belt operationally connecting pulleys mounted to said flexible coupling drive shafts.

13. A vibratory screening apparatus according to claim 8 wherein said mechanical synchronisation means includes an endless timing belt operationally connecting pulleys mounted to a rotational drive shaft of the rotary motion exciter cells located on the second side of said dynamic section of the first said pair, and the second said pair of the rotary motion exciter cells.

14. A vibratory screening apparatus according to claim 13 wherein the drive motor for each said first said pair and said second said pair of the rotary motion exciter cells are located on the first side of said dynamic section.

15. A vibratory screening apparatus according to claim 8 wherein some or all said drive motors are mounted to said static section.

16. A vibratory screening apparatus according to claim 1 wherein the first group and the second group of said rotary motion exciter cells have axes of rotation positioned perpendicular to direction of material flow on said screening deck and generally in line with said direction of material flow on said screening deck.

17. A vibratory screening apparatus according to claim 1 wherein the first group and the second group of said rotary motion exciter cells have axes of rotation positioned generally in the form of a triangle, with the axes of rotation of said first said pair and said second said pair of said rotary motion exciter cells being positioned generally adjacent to an upper extremity of the dynamic section and the axis of rotation of said third said pair of said rotary motion exciter cells being located below the axes of rotation of said first said pair and said second said pair of said rotary motion exciter cells.

18. A vibratory screening apparatus according to claim 1 wherein the first group and the second group of said rotary motion exciter cells have axes of rotation positioned generally in the form of a triangle, with the axes of rotation of the third said pair of said rotary motion exciter cells being positioned adjacent to an upper extremity of the dynamic section, and the axes of rotation of said first said pair and said second said pair of the rotary motion exciter cells being located at a lower position.

19. A vibratory screening apparatus according to claim 1 wherein the dynamic section includes side walls on either side of the screening deck that extend upwardly from and longitudinally along the screening deck.

20. A vibratory screening apparatus according to claim 19 wherein the side walls also extend downwardly from the screening deck.

21. A vibratory screening apparatus according to claim 19 wherein the screening deck is generally horizontal or inclined downwardly from the infeed end to the discharge end.

22. A vibratory screening apparatus according to claim 19 wherein an upper face of the screening deck is multi-sloped or concave curved in the longitudinal direction between the infeed end and the discharge end.

23. A vibratory screening apparatus according to claim 19 wherein the screening deck includes a plurality of longitudinally spaced transverse tubular support members connected at either end to a respective said side wall, said tubular support members having a circular cross section with a plurality of circumferentially extending flanges spaced along the length of the support member, the circumferentially extending flanges enabling longitudinally extending rails to be connected thereto, the longitudinally extending rails enabling screening panel modules to be connected to the longitudinally extending rails to form an upwardly directed face of the screening deck.

24. A vibratory screening apparatus according to claim 1 wherein said control means further controls operational parameters of said drive means including rotational speed of said rotary motion exciter cells and direction of rotation of said rotary motion exciter cells during operation of said vibratory screening apparatus.

25. A vibratory screening apparatus including a static section; a dynamic section including a screening deck; at least three rotary motion exciter cells mounted to said dynamic section whereby rotation of said rotary motion exciter cells imposes a vibratory motion on said dynamic section relative to said static section; drive means for rotationally driving each of said rotary motion exciter cells; and mechanical synchronisation means mechanically linking rotation of a first one of said rotary motion exciter cells to at least a second one of said rotary motion exciter cells with at least a third one of said rotary motion exciter cells not being linked by said mechanical synchronisation means, whereby rotation of at least said first and said second rotary motion exciter cells occur in a common rotational direction and are synchronised together.

26. A vibratory screening apparatus according to claim 25 wherein multiple said rotary motion exciter cells are provided arranged in pairs with each said pair having a respective said rotary motion exciter cell positioned on opposed sides of said dynamic section with the rotary motion exciter cells of each said pair being constrained to rotate in the same direction.

27. A vibratory screening apparatus according to claim 26 wherein said mechanical synchronisation means mechanically linking rotation of at least three said pairs of said rotary motion exciter cells.

28. A vibratory screening apparatus according to claim 25 wherein said common rotational direction is reversible.

29. A vibratory screening apparatus according to any one claim 25 wherein control means is provided configured to enable rotation of said third one of said rotary motion exciter cells in a rotational direction counter to said common rotational direction.

30. A vibratory screening apparatus according to claim 29 wherein rotation of said third one of said rotary motion exciter cells is synchronised electrically to said first one and said second one of said rotary motion exciter cells.

31. A vibratory screening apparatus according to any one claim 25 wherein rotation of said first one of said rotary motion exciter cells is also electrically synchronised to rotation of said second one of said rotary motion exciter cells.

32. A method of operating a vibratory screening apparatus having a static section, a dynamic section including a screening deck, at least three rotary motion exciter cells mounted to said dynamic section whereby rotation of said rotary motion exciter cells impose a vibratory motion on said dynamic section relative to said static section, and drive means being arranged to rotationally drive each of said rotary motion exciter cells; said method including providing:
mechanical synchronisation means for mechanically linking rotation of a first one of said rotary motion exciter cells to at least a second one of said rotary motion exciter cells whereby rotation of at least said first and said second rotary motion exciter cells occur in a common rotational direction; and
control means controlling at least direction of rotation of a third one of said rotary motion exciter cells, said method further including carrying out screening of ore particulate material on said screening deck while rotating at least said third one of said rotary motion exciter cells in a direction counter to said common rotational direction of at least said first and said second rotary motion exciter cells.

33. A method according to claim 32 wherein said control means also controls phase relationship of the third one of said rotary motion exciter cells relative to a selected one, or a group of, or all other said rotary motion exciter cells.
